(19) United States
(12) Patent Application Publication
(10) Pub. No.: US 2008/0082379 A1
(43) Pub. Date: Apr. 3, 2008

(54) Technical performance measures management process and system

(75) Inventors: Curtis R. Patterson, Lake Park, FL (US); William K. Barcza, Palm City, FL (US); Martin D. Bennett, Loxahatchee, FL (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED TECHNOLOGIES CORP.

(21) Appl. No.: 11/529,004

(22) Filed: Sep. 28, 2006

(51) Int. Cl. G06F 17/50

(52) U.S. Cl. 705/7

(57) ABSTRACT

A method for managing one or more technical performance measure parameters is provided. The method includes defining the one or more technical performance measures parameters and determining, tracking and trending one or more achieved capabilities and one or more projected capabilities of the one or more technical performance measures parameters.

### BACKGROUND OF THE INVENTION

1. Field of the Invention

This invention relates generally to management of data and, more particularly, to a system and method for managing product and product performance metrics data.

2. Description of the Related Art

Technical Performance Measures (TPMs) are typically a complex network of interrelated metrics for a product and/or a program at the system, subsystem and component level. A metric is a measure of a property. A metric may be a measure of a property for a product related to technical performance, such as, cost, weight, lifecycle, or any other property of the product. TPMs are usually identified and developed prior to the initiation of a program, but can also be developed during the course of a research, product development and/or product production program. TPMs are usually numerous in nature and are normally maintained by different people, while one person is commonly responsible for rolling-up and integrating TPM data for reporting purposes. Inherently, managing and tracking TPMs typically requires detailed tracking charts and a high degree of organizational structure; currently available methods lack structure and graphical constraints needed to consistently create and provide historical and progress reports related to TPM performance.

Accordingly, there is a need for an improved system and method of managing TPMs. There is a further need for a technical performance measures management database allowing for real time management, tracking and reporting of TPMs.

### SUMMARY OF THE INVENTION

A method for managing one or more technical performance measure parameters is provided. The method includes defining the one or more technical performance measures parameters and determining, tracking and trending one or more achieved capabilities and one or more projected capabilities of the one or more technical performance measures parameters.

A technical performance measures management system is also provided. The system includes a control processing unit having a user interface. The control processing unit defines one or more technical performance measures parameters and determines, tracks and trends one or more achieved capabilities and one or more projected capabilities of the one or more technical performance measures parameters.

A computer readable program embodied in an article of manufacture comprising computer readable program instructions for managing one or more technical performance measures is further provided. The program includes program instructions for causing a computer to define one or more technical performance measures parameters and program instructions for causing the computer to determine, track and trend one or more achieved capabilities and one or more projected capabilities of the one or more technical performance measures parameters.

The method may further comprise assessing risk based on the one or more achieved capabilities and the one or more projected capabilities to identify one or more identified risk items. The method may further comprise generating a report of a technical performance measure summary for the one or more technical performance measures parameters. The method may further comprise storing the one or more technical performance measures parameters on a data retention drive. Determining, tracking and trending may include defining dependencies of one or more higher level technical performance measures parameters on one or more lower level technical performance measures parameters. The one or more higher level technical performance measures parameters and the one or more lower level technical performance measures parameters may form a technical performance measurement parameter tree. Determining, tracking and trending may include entering and storing one or more key milestones for the one or more technical performance measures parameters and monitoring the one or more key milestones relative to the one or more technical performance measures parameters. Determining, tracking and trending may include establishing and storing one or more technical performance requirements for the one or more technical performance measures parameters and monitoring the technical performance requirements relative to the one or more technical performance measures parameters. Determining, tracking and trending may comprise associating the one or more technical performance measures parameters with a work breakdown structure. Determining, tracking and trending may include applying margin to the technical performance parameters. Determining, tracking and trending may include generating a technical performance plot that has values that are selected from the group consisting of a technical performance measure parameter value scale, an achieved-to-date trend line, a timeline, a requirement value, a requirement with development margin, an achieved to date nominal value, one or more achieved to date uncertainty values, a timeline scale, one or more key program milestones, a current estimate nominal value, one or more current estimate uncertainty values, and any combinations thereof. Determining, tracking and trending may include searching the one or more technical performance measures parameters based on a plurality of work breakdown structure groups.

The control processor may assess risk based on the one or more achieved capabilities and one or more projected capabilities to identify one or more identified risk items. The control processor may generate a report of a technical performance measure summary for the one or more technical performance measures parameters. The system may further comprise a data retention drive for storing the one or more technical performance measures parameters on a data retention drive.

The program may further comprise program instructions for causing the computer to assess risk based on the one or more achieved capabilities and one or more projected capabilities to identify one or more identified risk items. The program may further comprise program instructions for generating a report of a technical performance measure summary for the one or more technical performance measures parameters.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a schematic diagram of a system and method of conducting a technical performance measures management process;

FIG. 2 is an examplary screenshot showing an introduction module of a user interface for a system and method of conducting a technical performance measures management process;

FIG. 3 is an examplary screenshot showing a main menu database switchboard and a chart setup menu database switchboard of a user interface for a system and method of conducting a technical performance measures management process;

FIG. 4 is an examplary screenshot showing a Build TPM parameters Tree module of a user interface for a system and method of conducting a technical performance measures management process;

FIG. 5 is an examplary screenshot showing a TPM Tracking Chart Set-up module of a user interface for a system and method of conducting a technical performance measures management process;

FIG. 6 is an examplary screenshot showing an Establish TPM Requirements module of a user interface for a system and method of conducting a technical performance measures management process;

FIG. 7 is an examplary screenshot showing an Enter/Edit TPM Development Margin module of a user interface for a system and method of conducting a technical performance measures management process;

FIG. 8 is an examplary screenshot showing a manage TPM Parameters module of a user interface for a system and method of conducting a technical performance measures management process;

FIG. 9 is an examplary screenshot showing a TPM Summary Table of a user interface for a system and method of conducting a technical performance measures management process;

FIG. 10 is an examplary screenshot showing a manage TPM Parameters Plot module of a user interface for a system and method of conducting a technical performance measures management process;

FIG. 11 is an examplary detailed screenshot showing an example of a graph of a nominal Achieved-to-Date TPM performance value with uncertainties relative to a regularly statused TPM requirement all of which are generated by a system and method of conducting a technical performance measures management process;

FIG. 12 is an examplary screenshot showing an electronic TPM Summary Table report of a user interface for a system and method of conducting a technical performance measures management process;

FIG. 13 is an examplary screenshot showing a generic version of an examplary TPM plot field of a user interface for a system and method of conducting a technical performance measures management process;

FIG. 14 is an examplary screenshot showing a Table of Risk Level Definition for TPMs relative to requirements;

FIG. 15 an examplary screenshot showing a risk waterfall chart and process of assessing risk; and

FIG. 16 is a schematic diagram of the system and method of conducting a technical performance measures management process of FIG. 1.

### DETAILED DESCRIPTION OF THE INVENTION

A technical performance measures management process (TPMMP) of the present invention is a system and method for organizing, storing, and illustrating product data, such as, for example, program performance metrics. The TPMMP is a novel approach and robust business solution for risk based assessment and monitoring of program performance metrics (i.e. Technical Performance Measures Parameters). The TPMMP provides a methodology and tool base for continuous monitoring of achieved and projected capabilities of a product and/or product attributes relative to core requirements of a program in order to maintain compliance with predetermined requirements and predetermined acceptable risk level.

The TPMMP offers several novel and unique capabilities. The TPMMP can capture, store, and ensure accurate establishment, tracking and trending of technical performance measurements (TPM) parameters. The TPM parameters are one or more program performance metrics. The TPM parameters serve as key indicators of product alignment with requirements. Some examples are of TPMs are safety, reliability, system weight, mission life and product cost. The TPMMP facilitates streamlining of a TPM tracking process. The TPM parameters may be assessed and tracked relative to requirements using a disciplined approach that couples and compares Achieved-to-Date (ATD) levels of TPM performance with estimation of associated uncertainties resulting in more accurate prediction of performance levels at program completion. The TPMMP may conduct risk assessment by a TPM risk assessment approach that monitors TPMs relative to actual technical performance. Program risk levels may be derived based on uncertainties of individual TPM elements of a product relative to specific program requirements and program status. The TPMMP enables regular-high fidelity TPM reporting. Program risk management and mitigation capability may be realized at a much higher level of fidelity over prior art methods due to a close coupling of continuous TPM status assessment and an ability to ascertain risk levels relative to uncertainties and program requirements. TPM summaries may be regularly generated and reported to provide ‘program-wide’ visibility or accessibility to technical performance.

The TPMMP is integrated into a Technical Performance Measures Management Database (TPMMD). The TPMMD may store and retrieve information in accordance with the input of one or more users; the application flexible and can be tailored to address the TPM Management, Tracking and Trending requirements for a variety of programs. The TPMMD is a turnkey e-business tool that allows for highly efficient real time management and tracking of TPMs and TPM parameters. The TPMMD may capture and store all facets of technical performance measures management (TPMM) and render TPMM logic and methodology in a succinct user-friendly format.

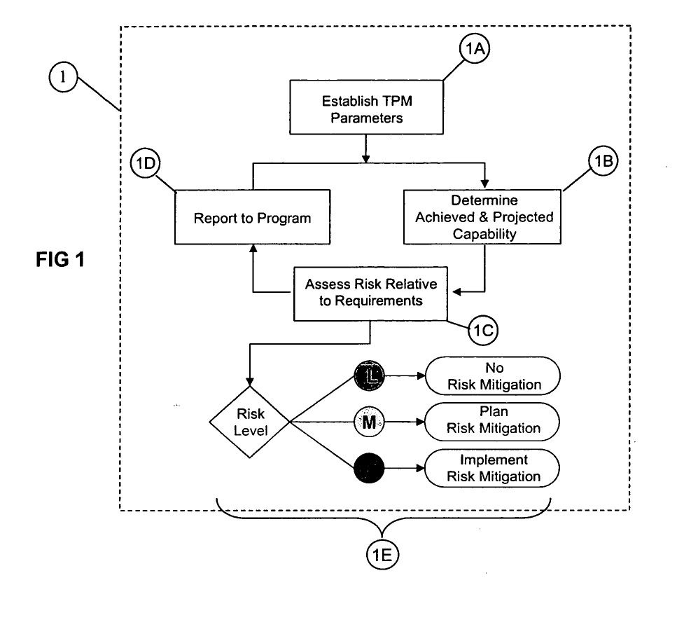

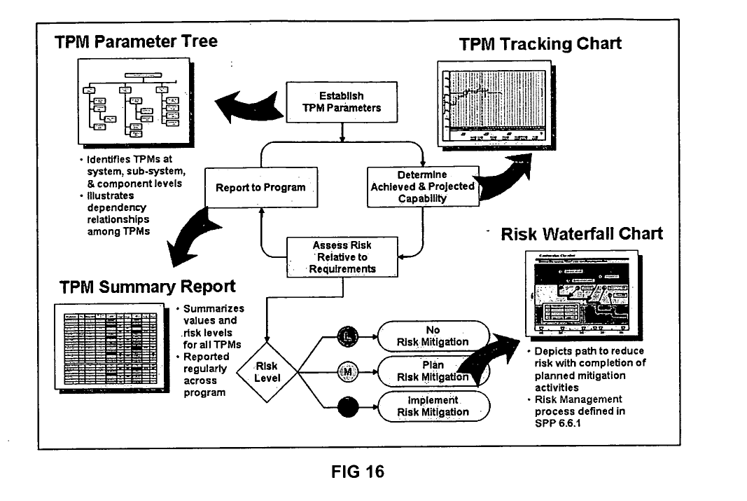

Referring now to FIGS. 1 and 16, a block diagram is shown of a method of the TPMMP that is referred to by reference numeral 1. The method 1 includes establishing or defining TPM parameters for one or more products, as shown by Step 1A. TPM parameters are indicators of product alignment with predetermined requirements over the life of a program.

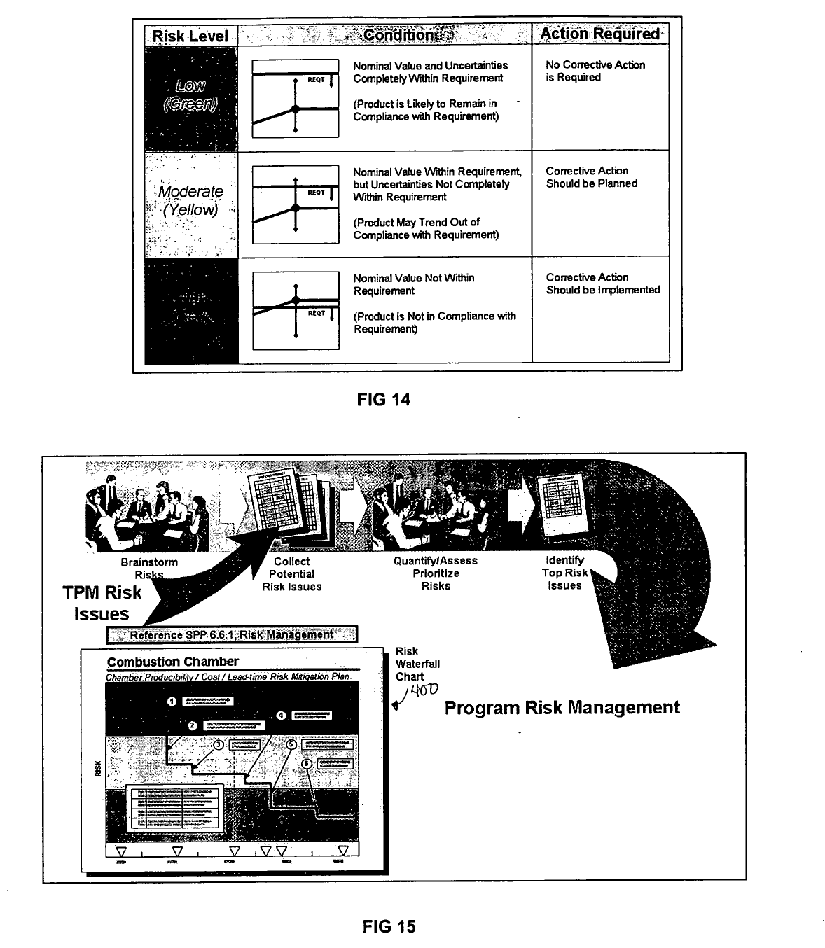

Achieved and projected capabilities are determined and tracked over time relative to the TPM parameters defined in Step 1A, as shown in Step 1B. Risk is assessed based on the capabilities determined in Step 1B, tracking and trending with time, and calculated uncertainties, as shown in Step C. As an example, weight is a TPM that frequently varies significantly over the course of a program; conservatively uncertainty can be added to the Achieved-to-Date (ATD) nominal value for weight as the components, subsystem and/or system of a configuration mature in anticipation of component or system growth. Conversely, negative uncertainty can be applied to a given ATD nominal value for weight with respect to opportunities such as the use of lighter alloys which may favorably affect weight. Application of uncertainty to ATD nominal values is optional in both the TPMMP and TPMMD. The TPMMP and TPMMD allow assessment of risk based on the relationship of ATD nominal values and their associated uncertainties with TPM requirements and any associated requirement margin as shown in FIG. 13. FIG. 14 provides a Table of Risk Level Definition for TPMs relative to requirements. The identified risk items assessed in Step 1C may then be addressed and mitigated using a standard risk management process (e.g. risk waterfall chart 400, FIG. 15), as shown in Step 1E. A TPM summary for at least one product is utilized and reported regularly to provide program wide visibility and accessibility to the historical, current and projected status of TPMs being tracked, as shown in Step 1D. This method of TMP Risk assessment assures efficient and well disciplined product maturity that leads to fulfillment of customer expectations relative to the prescribed suite of TPM parameters for a program.

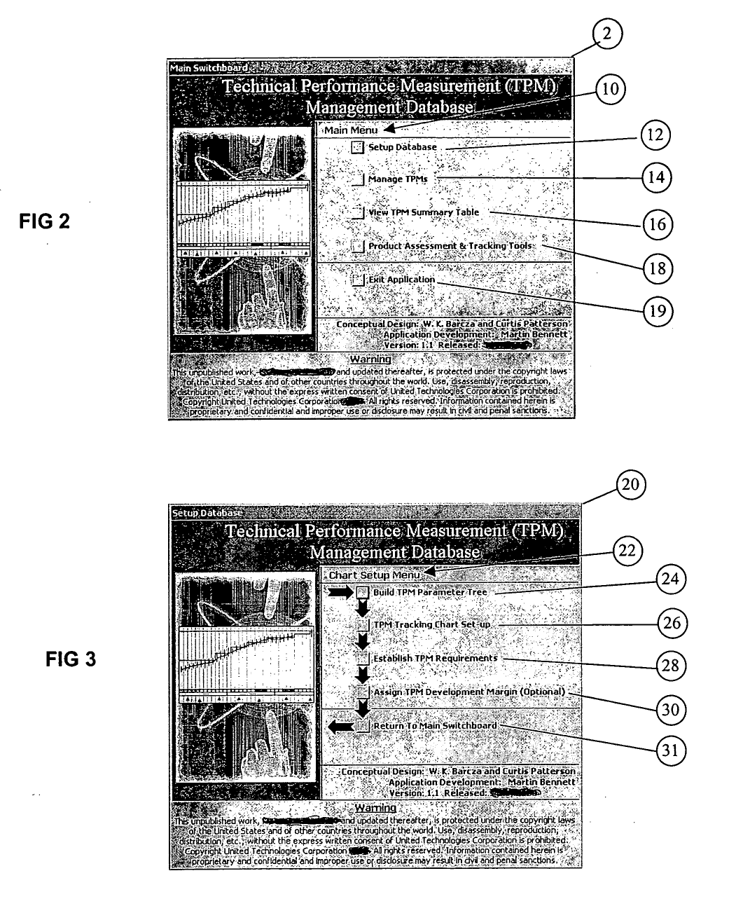

Referring now to FIGS. 2 through 10, a plurality of screen shots of various display modules of the TPMMD program are illustrated. The TPMMD program is an example of suitable software used in conjunction with a host computer for developing tracking and managing TPMs of a product in accordance with method 1. The host computer is described herein by way of example as a control processing unit. Of course, it is contemplated by the present disclosure for the host computer to include any programmable circuit, such as, but not limited to, computers, processors, microcontrollers, microcomputers, programmable logic controllers, application specific integrated circuits, and other programmable circuits. It is further contemplated by the present disclosure that the host computer is any number of control devices providing various types of control, e.g., centralized, distributed, redundant and/or remote control. As discussed in further detail below, the TPMMD program is capable of generating and retaining a complete record of the TPMMP, thereby allowing a user to electronically correspond with peers relative to a particular TPMMP and have highly detailed documentation to support resulting product performance records.

FIG. 2 shows an introduction module 2 of the TPMMD program. The introduction module 2 includes a main menu 10. The main menu 10 includes a Setup Database button 12, a Manage TPMs button 14, a View TPM Summary button 16, a Product Assessment & Tracking Tools button 18, and/or an Exit Application button 19. The user may select one of buttons 12, 14, 16, 18, and/or 19 to access another module of the TPMMD program.

Setup Database button 12 provides access to a Setup Database switchboard 20, as shown in FIG. 3. The Setup Database switchboard 20 allows the user to utilize a Chart Setup Menu 22. The Chart Setup Menu 22 may include a Build TPM parameter Tree button 24, a TPM Tracking Chart Set-up button 26, an Establish TMP Requirements button 28, an Assign TPM Development Margin button 30 (Optional), and/or a Return To Main Switchboard button 31. The Build TPM parameter Tree button 24 may be selected for building a TPM parameter tree. The TPM Tracking Chart Set-up button 26 may be selected for TPM tracking chart set-up and tailoring with respect to specific program attributes and/or requirements. The Establish TMP Requirements button 28 may be selected for establishing TMP requirements. The Assign TPM Development Margin button 30 may optionally be selected for assigning TPM development margin. The Return To Main Switchboard button 31 may be selected for returning to main menu 10.

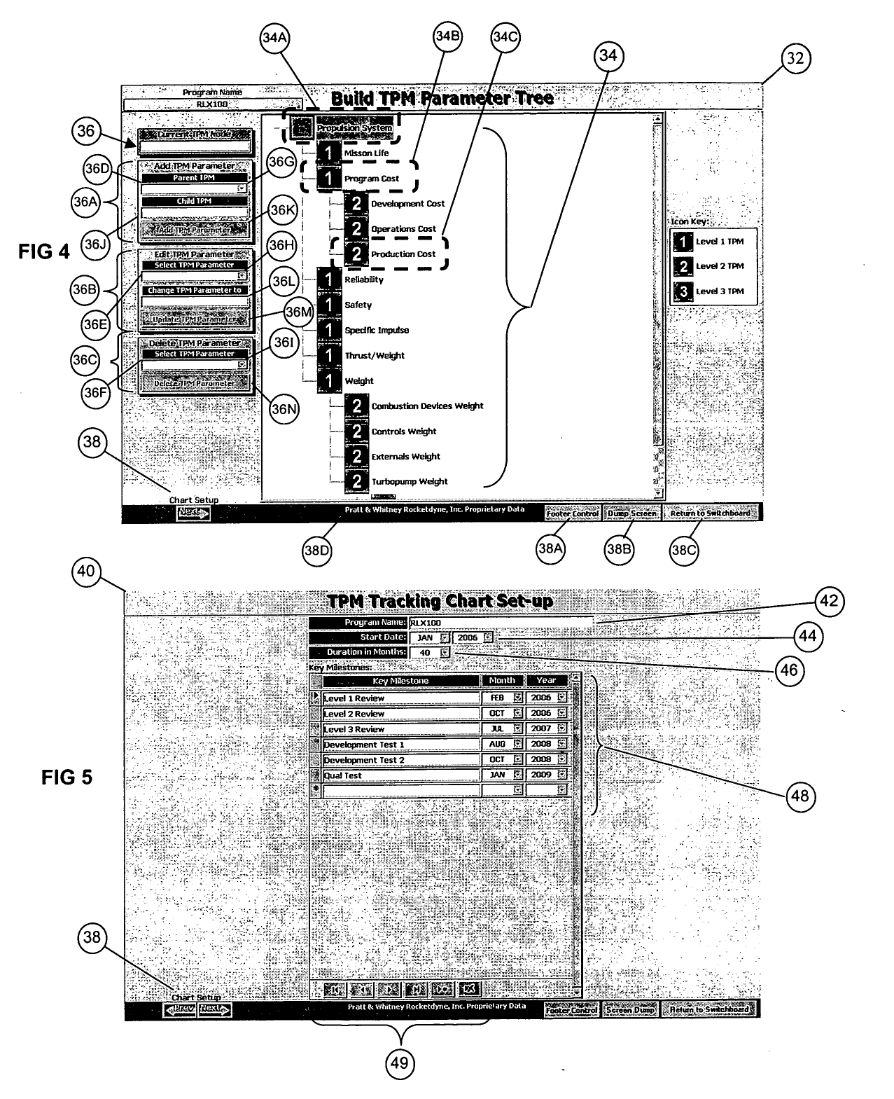

The user may select Build TPM parameter Tree button 24 from Chart Setup Menu 22 to access a build TPM parameters tree module 32, as shown in FIG. 4. The user develops TPM parameters in build TPM parameters tree module 32. The build TPM tree module 32 may employ a ‘parent-child’ relationship approach that results is a TPM parameter tree 34 that has a structure that demonstrates dependencies of higher level TPM parameters on lower level TPM parameters. The TPM parameter tree 34 may also drive proper allocation of TPMs to ensure top-to-bottom accountability for technical performance.

A Current TPM Node cell 36 identifies which TPM parameter is currently selected. TPM parameters can be selected by clicking directly on a TPM parameter of interest in TPM parameter tree 34. The selected/currently active TPM parameter from the TPM Parameter Tree 34 is automatically populated in Current TPM Node cell 36. Subsequently, a Parent TPM cell 36D of an Add TPM parameter field 36A is populated with a Parent TPM drop down list 36G consisting, of all TPMs in the TPM Parameter Tree 34. TPM parent-child relationships are established by selecting a TPM from the Parent TPM drop down list 36G by clicking once in the Parent TPM cell 36D then clicking on the appropriate TPM parent in the TPM Parameter Tree 34 then subsequently inputting the requisite nomenclature of the desired child TPM in the Child TPM field 36J. The Add TPM Parameter button 36K is initially greyed out but becomes active once input for a child TPM name has been entered. At this point, clicking on the Add TPM Parameter button 36K results in the newly inputted child TPM being added and displayed in the TPM parameter tree 34 along with the pre-existing TPMs. The relationship of the child TPM to its parent TPM is reflected in the structure of the TPM Parameter Tree 34. TPM parameters in the TPM parameter tree 34 are assigned icons 1 and greater, such as, for example, 1, 2, or 3, in accordance with a hierarchy in a series of parent-child relationships. Each of Parent TPM cell 36D, Select TPM parameter cell 36E, and Select TPM parameter cell 36F may be independently populated with any existing TPM parameter by using one or more of integrated drop down menus 36G, 36H, 36I. The Add TPM parameter field 36A facilitates establishment of parent-child relationships in TPM parameter tree 34. Child TPM parameters are created by inputting a requisite nomenclature into a Child TPM cell 36J of Add TPM parameter field 36A. The Edit TPM parameter field 36B allows for changing of nomenclature for any given TPM parameter. The Delete TPM parameter field 36C allows for deletion of TPM parameters. TPM parameters may be deleted, for example, either because they are incorrect or are no longer of interest with respect to the TPMMP.

Chart Setup navigation buttons 38 allow users to navigate through modules, such as, for example, Build TPM parameters Tree module 32 and TPM Tracking Chart Set-up module 40, Establish TPM Requirements module 50, and Enter/Edit TPM Development Margin module 60, described below in detail, that fall under the Chart Set up menu 22. A Footer Control button 38A modifies a footer content 38D, which appears in all modules and forms of the TPMMD and on all forms generated by the TPMMD. Footer content may include, for example, a notice of proprietary data. A Screen Dump button 38B captures an image of a current view of Build TPM parameters Tree module 32 shown on screen. Captured images can readily be imported into other programs and/or documents capable of receiving images. A Return to Switchboard button 38C returns the user to TPMMD Setup Database Switchboard 20. The Footer Control button 38A, Screen Dump button 38B, and/or Return to Switchboard button 38C may appear in all modules included in the TPMMD program.

Referring now to FIG. 5, an examplary screen shot of a TPM Tracking Chart Set-up module 40 is illustrated. The user may select TPM tracking Chart Set-up button 26 to access TPM Tracking Chart Set-up module 40. A Program Name cell 42, a Start Date cell 44, and a Duration cell 46 may be included in the TPM Tracking Chart Set-up module 40. The user may input a selected program name in Program Name cell 42. Key milestones for a particular program and/or product are entered by the user in the Key Milestones table 48. Key Milestones are, for example, status of the program in alignment with a date of inputted key milestones that must be achieved. The user may input a start date in Start Date cell 44 and a duration in Duration cell 46 of a program key milestone for the selected program. The TPMMD program stores the program key milestone and may monitor the product and/or program in relation to the program key milestone.

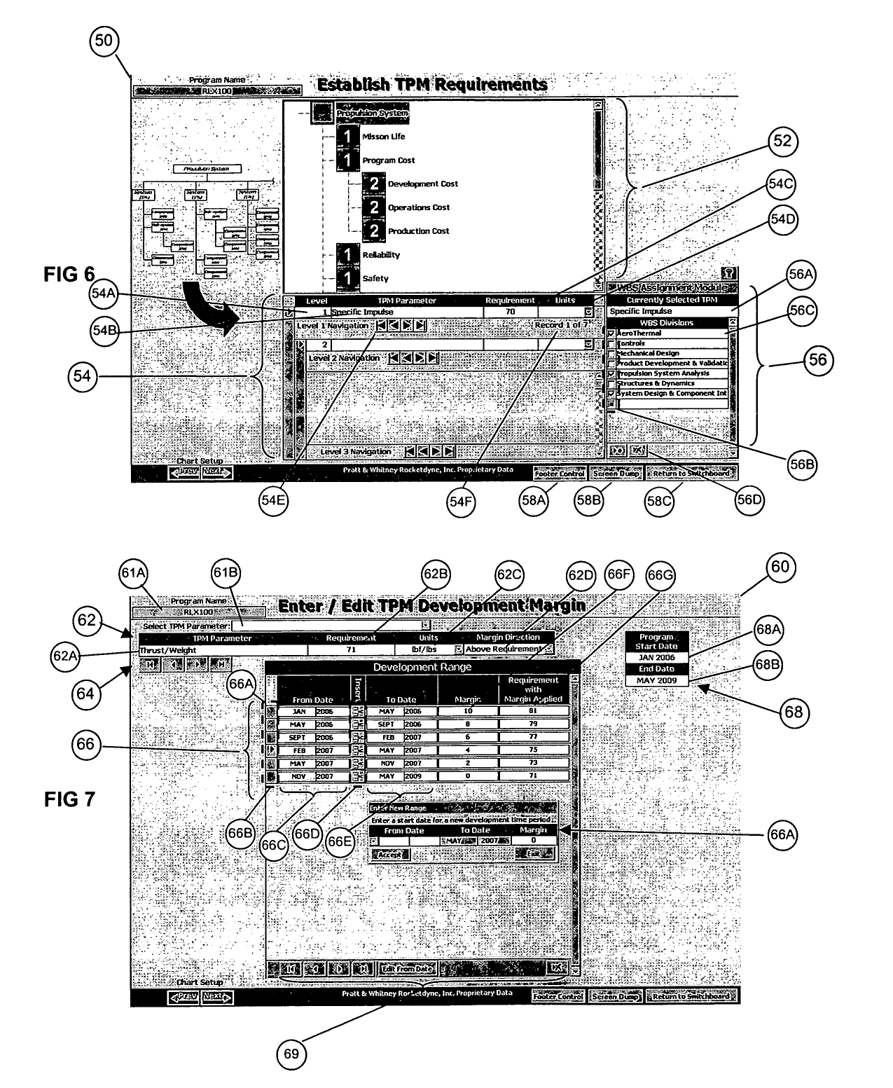

Referring now to FIG. 6, TPM requirements are established and entered in an Establish TPM Requirements module 50. The user may select Establish TPM Requirements button 28 to access Establish TPM Requirements module 50. A TPM parameter requirement field 54 may have a tiered three level structure for entry of TPM requirements. TPM Parameter nomenclature is contained in TPM Parameter cell 54B. Cells 54C and 54D allow for input of requirement values and associated units for requirements, respectively. The TPM parameters are assigned to three different levels of the tiered three level structure in accordance with dependency of one another and a subsequent hierarchy in the TPM parameter tree 34; Level cell 54 A, reflects the tier level structure for TPMs in accordance with TPM hierarchy Record ID feature 54F denotes the ID number for a selected record along with the total number of TPMs for the same tier. A viewing field 52 contains a scrollable static display of TPM parameter tree 34 from Build TPM Parameter Tree module 32. The WBS Assignment Module field 56 allows for association of one or more TPM parameters in accordance with a work breakdown structure (WBS) of one or more predetermined WBS. In the TPM parameter requirement field 54 the user selects a TPM parameter using navigation tools 54E, for WBS association such as, for example, a box 56B that may be checked by the user. The TPM parameter that is selected appears in a Currently Selected TPM cell 56A of the WBS assignment module field 56. WBS associations are made by selecting check boxes 56B in WBS Assignment Module field 56. TPM-WBS associations facilitate convenient search capability in a TPM Summary Table 80, described below (e.g. a user may be only concerned with viewing TPMs associated with a particular discipline, such as Mechanical Design). The WBS Assignment Module field 56 also allows for tailoring, for example, adding or editing WBS appointments to suit needs of a particular program. Tailoring of the TPM-WBS associations includes deleting WBS appointments. Specifically an editorial button suite facilitates adding, editing and/or deleting WBS appointments. The Currently Selected TPM field 56, by default, is pre-populated with a predetermined default WBS.

Referring now to FIG. 7, as an option, margin may be applied to the TPM parameters using an Enter/Edit TPM Development Margin module 60. The user may select Assign TPM Development Margin button 30 to access Enter/Edit TPM Development Margin module 60. Margin is a value that may be applied for TPM parameters that historically trend unfavorably through design and development and therefore, is adjusted over time through the maturation of the design and product development cycles. TPM parameters requiring margin are selected from a drop down menu in a Select TPM Parameter cell 62. A currently selected TPM cell 64 denotes a currently selected TPM parameter 62A. A currently selected TPM requirement value 62B, preferably, is one or more of the TPM requirements established in Establish TPM Requirements module 50. A currently selected TPM associated units 62C are units of the currently selected TPM parameter selected from a drop down menu in a Select TPM Parameter cell 62. A currently selected TPM margin direction 62D describes whether margin of the currently selected TPM is a higher or lower than currently selected TPM requirement value 62B. The currently selected TPM margin direction 62D defaults as either ‘Above Requirement’ or ‘Below Requirement’ based on whether positive or negative values are entered by the user for margin.

Margin can be added incrementally for specific periods of time in a Development Range field 66. New intervals for margin adjustment are created by the user selecting one of insert buttons 66B in Development Range field 66 in accordance with a From Date cell 66C and To Date cell 66E that is inputted by the user. The user may select one of insert buttons 66D to open an Enter Range sub-utility 66A where the user may input values for new intervals of margin adjustment. As previously stated margin can be entered as positive or negative values. As a non-limiting example, for a rocket engine program a TPM parameter such as weight typically would have negative margin applied whereas a TPM like thrust typically would have positive margin applied since an application typically is to reduce weight and maximize thrust. For posterity, a previously determined, program start date and end date field 68 shows a previously determined program start date 68A and a previously determined end date 68B.

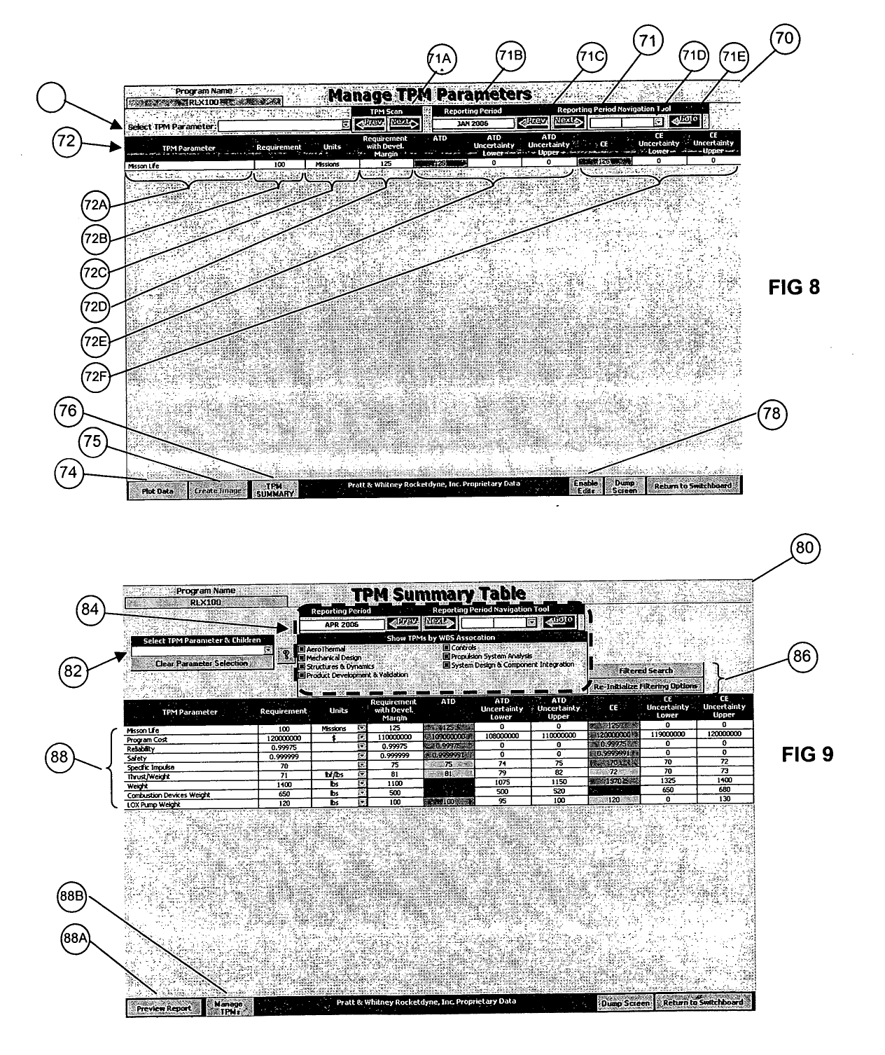

The Manage TPMs button 14 of introduction module 2 provides access to a Manage TPM Parameters module 70, as shown in FIG. 8. The Manage TPM Parameters module 70 allows for detailed management and tracking of TPM parameters and TPM performance on, such as, for example, a monthly basis. The TPM parameters module 70 includes an Enable Edits button 78 that a user may select to fully activate a Select TPM Parameter Selection field 72. The TPM parameters of interest can be selected from a dropdown menu or using a TPM Scan tool 71A. A monthly reporting period is selected/identified by using a scanning option or dropdown menu both of which are available under the Reporting Period Navigation Tool 71B. Cells 72A-72D are non-editable and provide an active TPM parameter name, TPM requirement value, requirement units and requirement value with margin added, respectively.

The TPM parameters module 70 includes ATD cell group 72E and CE cell group 72F that allows user inputs for TPM performance ATD (Achievement-To-Date) and CE (Current Estimate) data. ATD data are values that represent achieved results through technical progress to date as measured, calculated or estimated by analysis, test inspection, demonstration, etc. The ATD cell group 72E allows for user input of nominal ATD and ATD lower and upper bounds. The lower and upper bounds are uncertainties that represent potential values that could result from known issues and/or are based on influential developments that may not yet be certain, confirmed, quantified, concluded, etc. FIG. 11 is an example of a graph generated by the TPMMD program that includes graphical depictions of an ATD nominal value 212, an ATD upper bound 210, and an ATD lower bound 214. The referenced uncertainties may not account for possible trending due to unknown causes as this effect may be accounted for and addressed by trending. CE cell group 72F allows for user input of a nominal CE as well as current estimate lower bound and current estimate upper bound. CE data represents projected or expected result for a TPM parameter at a culmination of a program or at a future program or product milestone. ATD values vary month-to-month based on user input while the CE data, while editable, will have the same value for all monthly periods throughout a program.

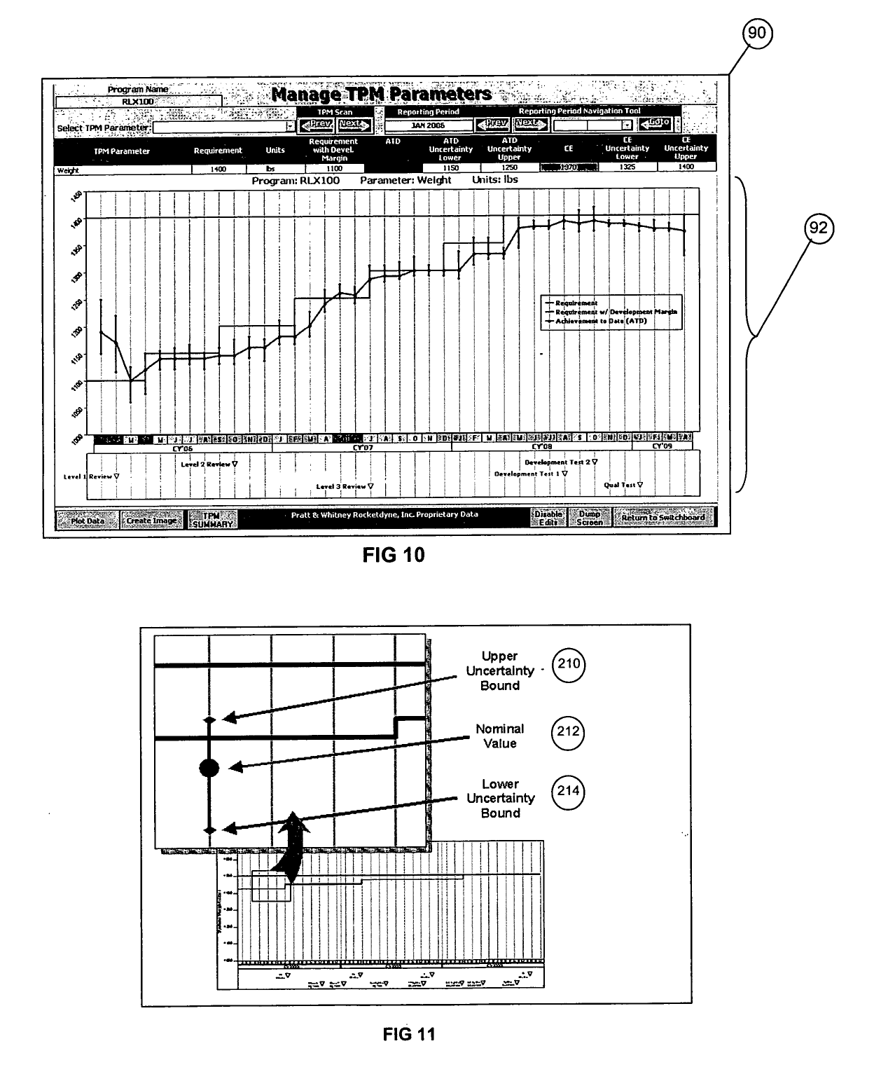

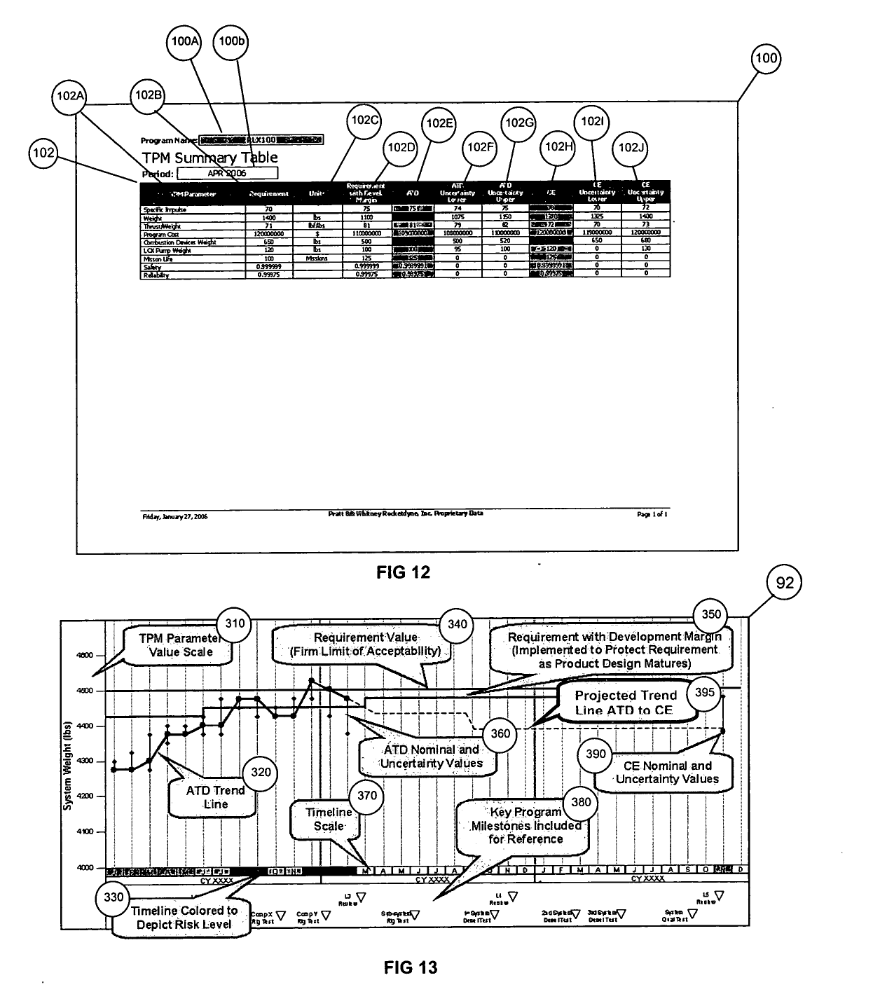

The TPM Parameters module 70 includes TPM Summary button 76 that provides access to a TPM Summary Table module 80, as shown in FIG. 9, when selected by the user. The TPM Parameters module 70 includes Plot Data button 74 that provides access to the TPM Plot field 92 of a Manage TPM parameters Plot module 90, as shown in FIG. 10, when selected by the user. The TPM Summary Table module 80 displays a comprehensive view of all TPMs for a program over a given period, for example, monthly. A Select TPM parameter & Children cell 82 allows users to select TPM parameters along with all of their downstream relatives or related TPM parameters that are lower in a hierarchy. As a non-limiting example, by selecting Weight, Combustion Device Weight, Turbomachinery Weight, LOX Pump Weight and so on would also be selected for display in the summary table display field 88. A TPM Summary Table Query utility 84 that allows for specific TPM searches based associated WBS groups (e.g. users can request display of TPM parameters that have association with Mechanical Design only and Structures and Dynamics only by making the proper WBS selections). The user may select a Filtered Search button 86 to execute a filtered TPM query based on selected WBS. A Preview Report button 88A and Manage TPM button 88B allow for user preview of an electronic TPM Summary Report 100 in FIG. 12 and for users to return to the Manage TPM parameters module 70, respectively. The TPM Summary Report 100 may include TPM parameters, TPM requirements, TPM units, TPM margin, ATD uncertainty lower bound, ATD uncertainty upper bound, CE, CE lower bound, and/or CE upper bound for one or more TPMs. A color coded system reflects the risk condition and indicate action required for TPM values ATD field 102E and TPM CE values in field 102H based on the risk condition definition in FIG. 14.

FIG. 10 illustrates a Manage TPM parameters Plot module 90. The Manage TPM parameters Plot module 90 is identical to Manage TPM parameters module 70 with a TPM Plot field 92 with a plot of a performance for the selected TPM. FIG. 13 shows a generic version of an examplary TPM Plot field 92. The examplary TPM Plot Field 92 may include a TPM parameter value scale 310, an ATD trend line 320, a timeline 330, a requirement value 340, a requirement with development margin 350, ATD nominal and uncertainty values 360, a timeline scale 370, key program milestones 380, and/or CE nominal and uncertainty values 390. The TPM parameter value scale 310 is an axis including values of a selected TPM parameter, for example, system weight in pounds, as shown in FIG. 13. The ATD trend line 320 connects plotted points of TPM parameter 310 to timeline 330. The timeline 330 is an axis including indicators of dates that may also include indicators, such as color, to indicate risk level. The requirement value 340 includes a predetermined value, such as, a TPM requirement that is established and entered in Establish TPM Requirements module 50. The requirement with development margin 350 includes, for example, a TPM requirement that is established and entered in Establish TPM Requirements module 50 with margin established in margin module 60. The ATD nominal value and uncertainties 360 are analogous to ATD nominal value and uncertainties, respectively 214, 210 and 212, as shown in FIG. 11. The timeline scale 370. The key program milestones 380, for example, are the key milestones established in TPM Tracking Chart Set-up module 40. The CE nominal and uncertainty values 390 are, such as, the nominal CE as well as current estimate lower bound and current estimate upper bound established in Manage TPM parameters module 70.

The TPMMP and TPMMD ensure a thorough and disciplined approach with respect to capturing and illustrating the, often complex, interrelated network of TPMs for a product or program. Each establishes a clear hierarchical path that conveys how lower level TPMs stream into higher level TPMs. The TPMMD readily facilitates an otherwise tedious documentation task via a highly flexible user friendly format. The database e-business tool also provides a common location and portal for users to access and contribute to TPM data for a product and/or program while saving time and eliminating variation in reporting charts. The TPMMP and TPMMD take a proactive approach towards risk management throughout the evolution of a program.

The TPMMP and TPMMD ensure that product requirements are met via effective TPM management, tracking and reporting throughout the development cycle of a product and/or life of a program. The benefits of this TPM management tool set are overreaching and are not limited to a particular discipline or industry. The TPMMP and the TPMMD may render cost savings, improve efficiency and productivity of business. The TPM management tool set also enables a vast spectrum of industrial consumers to take a proactive approach towards risk mitigation through effective technical performance measures management.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the appended claims.

What is claimed is:

1. A method for managing one or more technical performance measure parameters, the method comprising:
defining the one or more technical performance measures parameters; and
determining, tracking and trending one or more achieved capabilities and one or more projected capabilities of the one or more technical performance measures parameters.

2. The method of claim 1, further comprising assessing risk based on said one or more achieved capabilities and said one or more projected capabilities to identify one or more identified risk items.

3. The method of claim 1, further comprising generating a report of a technical performance measure summary for the one or more technical performance measures parameters.

4. The method of claim 1, further comprising storing the one or more technical performance measures parameters on a data retention drive.

5. The method of claim 1, wherein said determining, tracking and trending comprises defining dependencies of one or more higher level technical performance measures parameters on one or more lower level technical performance measures parameters.

6. The method of claim 5, wherein said one or more higher level technical performance measures parameters and said one or more lower level technical performance measures parameters form a technical performance measurement parameter tree.

7. The method of claim 1, wherein said determining, tracking and trending comprises entering and storing one or more key milestones for the one or more technical performance measures parameters and monitoring said one or more key milestones relative to the one or more technical performance measures parameters.

8. The method of claim 1, wherein said determining, tracking and trending comprises establishing and storing one or more technical performance requirements for the one or more technical performance measures parameters and monitoring said technical performance requirements relative to the one or more technical performance measures parameters.

9. The method of claim 1, wherein said determining, tracking and trending comprises associating the one or more technical performance measures parameters with a work breakdown structure.

10. The method of claim 1, wherein said determining, tracking and trending comprises applying margin to said technical performance parameters.

11. The method of claim 1, wherein said determining, tracking and trending comprises generating a technical performance plot that has values that are selected from the group consisting of a technical performance measure parameter value scale, an achieved-to-date trend line, a timeline, a requirement value, a requirement with development margin, an achieved to date nominal value, one or more achieved to date uncertainty values, a timeline scale, one or more key program milestones, a current estimate nominal value, one or more current estimate uncertainty values, and any combinations thereof.

12. The method of claim 1, wherein said determining, tracking and trending comprises searching the one or more technical performance measures parameters based on a plurality of work breakdown structure groups.

13. A technical performance measures management system comprising:
a control processing unit having a user interface, said control processing unit defines one or more technical performance measures parameters and determines, tracks and trends one or more achieved capabilities and one or more projected capabilities of said one or more technical performance measures parameters.

14. The system of claim 13, wherein said control processor assesses risk based on said one or more achieved capabilities and one or more projected capabilities to identify one or more identified risk items.

15. The system of claim 13, wherein said control processor generates a report of a technical performance measure summary for said one or more technical performance measures parameters.

16. The system of claim 13, further comprising a data retention drive for storing said one or more technical performance measures parameters on a data retention drive.

17. A computer readable program embodied in an article of manufacture comprising computer readable program instructions for managing one or more technical performance measures, said program comprising:
program instructions for causing a computer to define one or more technical performance measures parameters; and
program instructions for causing said computer to determine, track and trend one or more achieved capabilities and one or more projected capabilities of the one or more technical performance measures parameters.

18. The program of claim 17, further comprising:
program instructions for causing said computer to assess risk based on said one or more achieved capabilities and one or more projected capabilities to identify one or more identified risk items.

19. The program of claim 17, further comprising:
program instructions for generating a report of a technical performance measure summary for the one or more technical performance measures parameters.

20. A system, process or method for managing one or more technical performance measures as herein before described with reference to any one of FIGS. 1 through 13 of the accompanying drawings.
